(19) United States
(12) Patent Application Publication
(10) Pub. No.: US 2002/0105493 A1
(43) Pub. Date: Aug. 8, 2002

(54) DRIVE CIRCUIT FOR DISPLAY APPARATUS

(76) Inventor: NAOAKI KOMIYA, OGAKI-SKI (JP)

Correspondence Address: HOGAN & HARTSON L.L.P., 500 S. GRAND AVENUE, SUITE 1900, LOS ANGELES, CA, 90071-2611, US

(21) Appl. No.: 09/353,857

(22) Filed: Jul. 15, 1999

(30) Foreign Application Priority Data
Jul. 16, 1998 (JP) 10-202283

(51) Int. Cl. G09G 3/36

(52) U.S. Cl. 345/98

(57) ABSTRACT

A display apparatus with built-in digital driver includes a decoder (1) and a selector (2) formed from p-SiTFT CMOS circuits, and signal sources (31, 32, 33, 34). Input digital data DATA1 and DATA2 are decoded at the decoder (1) and control signals DC1, DC2, DC3, and DC4 are sent to the selector (2). In response to this, the selector (2) selects a signal having a different amplitude from the signal sources (31, 32, 33, 34) and sends it to a video line (6).

### BACKGROUND OF THE INVENTION

1. Field of the Invention

The present invention relates to a drive circuit for display apparatus.

2. Description of the Related Art

Flat-panel displays, such as liquid crystal displays (LCD), organic electroluminescence (EL) displays, and plasma displays, are actively being developed. Superior in terms of low power consumption among the flat-panel displays, the LCD has become the dominant type of monitor display in the fields of audio-visual equipment and office automation equipment.

The LCD has liquid crystals filled between a pair of opposing substrates. On the inner facing surface of each substrate are formed a large number of electrodes for driving the liquid crystals by furnishing an electric field on the liquid crystals, and display pixels are configured as capacitors with the liquid crystals as a dielectric layer.

Along with the advance in digital technology in recent years, LCDs are being used as monitors for digital equipment. It is possible to form high-speed semiconductor elements on an insulating substrate through the use of techniques to form polycrystalline semiconductors, in particular of poly-silicon (p-Si), at a low temperature below the thermal breakdown temperature of the substrate. As a result, LCDs with built-in drivers are now being fabricated by integrating not only the switching elements for the display pixels but the driver circuit for these switching elements onto the same substrate.

Although LCDs are generally driven by analog signals, under these circumstances, LCDs with built-in digital drivers are being developed.

FIG. 1 shows a configuration of the LCD with built-in digital driver of the prior art.

The lower part of the drawing is a display pixel area where gate lines 71 and so forth, and drain lines 81, 82, and so forth are arranged so as to intersect, and at each intersection are formed a pixel area TFT 90, and a liquid crystal capacitor 91 and an auxiliary capacitor 92, which are connected in parallel with respect to the pixel area TFT 90.

In the periphery of the display pixel area on the same substrate as the display pixel area are formed a gate driver area (not shown) for supplying a scan signal to the gate of the pixel area TFT 90 and a digital drain driver area (shown above the display pixel area) for supplying a pixel signal to the drain of the pixel area TFT 90.

The digital drain driver area is configured from circuit elements for transmitting corresponding analog pixel signals from the input digital data DATA1 and DATA2 to the drain lines 81, 82, and so forth.

The digital drain driver area comprises, as common elements, horizontal shift registers 101, 102, and so forth, video lines 111, 112, and first to fourth signal sources 161 to 164 with each having different voltage levels (signal levels V1 to V4). Since the input digital data signals (DATA1, DATA2) have two bits for four gray scale levels in the example shown in FIG. 1, each bit of the 2-bit input digital data DATA1 and DATA2 is assigned to the two video lines 111, 112.

At the digital drain line area, the configuration for every drain line 81 comprises sampling switches 121, 122, a first data hold capacitor 131, a data transfer control line 140, transfer switches 141, 142, a second data hold capacitor 144, a decoder 150 for converting 2-bit digital data into four types of control signals, and a selector 170 for selecting and outputting a signal source to the drain line in accordance with control signals.

In this configuration, the horizontal shift registers 101, 102, and so forth are started by start pulses (not shown) and shift operations are controlled in accordance with shift clocks (not shown). Simultaneously with when the horizontal shift registers 101, 102, and so forth are started, digital video data DATA1 and DATA2 are supplied to each video line 131, 132. First, at the first column , a sampling pulse SP1 that is output from an output stage shift register of the horizontal shift register 101 turns on two sampling switches 121, 122. At this time, digital video data DATA1 and DATA2 are supplied to the video lines 111, 112 in correspondence to the pixels to be illuminated, and the digital data is written to the capacitors 131 via the selected sampling switches 121, 122. Sequential sampling signals SP1, SP2, and so forth are output during one horizontal period from the horizontal shift registers 101, 102, and by the corresponding sampling switches 121, 122, the digital DATA1 and DATA2 are sampled and written to the first data hold capacitors 131 (Cl). During one horizontal period, at the completion of sampling of the digital input video data DATA1 and DATA2 respectively corresponding to all drain lines 81, 82, and so forth, intersecting with one gate line 71, a transfer signal WR is supplied to a transfer control line 140. In accordance with the transfer signal WR, the transfer switches 141, 142 are controlled so as to both turn on, and to the second data hold capacitors 144 connected respectively to each switch 141, 142 are written the digital data signals that were held in the first data hold capacitors 131.

The decoder 150 provided at the drain line 81 comprises inverters, NAND gates, and NOR gates, and outputs control signals DC1 to DC4 to the selector 170 that is connected to the signal source 160 on the basis of the combination (high, low) of DATA1 and DATA2 held in the second data hold capacitors 144.

The selector 170 comprises 2ⁿ (where n=2 in this example, or 4 switches) selector switches 181 to 184 corresponding to control signals DC1 to DC4, and to each switch 181 to 184 is connected one of first to fourth signal sources 161 to 164 having mutually different voltage levels (V1 to V4). For example, if the decoder 150 decodes DATA1 and DATA2 and outputs control signal DC1, namely, a high-level control signal DC1, then at the selector 170, the selector switch 181 turns on from the high-level control signal DC1, and the voltage signal V1 is output, through the selector switch 181, to the drain line 81 from the corresponding first signal source.

Thus, from the circuit configuration given above, the LCD of FIG. 1 is driven by a so-called line-sequential drive system. For all drain lines in a line along one horizontal direction, analog pixel signals corresponding to the respective digital input data DATA1 and DATA2 are output simultaneously. Furthermore, at this time, the pixel area TFTs 90 connected to the selected gate line 71 are controlled so as to turn on, and the pixel signals supplied to drain lines 81, 82, and so forth are written to the pixel capacitors 91, 92 in a line along one horizontal direction.

The circuit elements of the above-mentioned digital drain driver area are composed of p-Si TFT elements formed on the same substrate with the pixel area TFTs 90.

In the LCD of FIG. 1, the digital input video data DATA1 and DATA2 are converted to analog pixel signals for every drain line by the digital drain driver area built into the substrate of the LCD, and the display operations at the display pixels are performed by the analog pixel signals.

Therefore, since a display signal transmitted in a digital format or a digitally-processed display signal can be directly supplied to the LCD, D/A converters become unnecessary at the output device side of the display signals, thereby reducing the size of the circuits connected externally to the LCD and greatly reducing costs. Furthermore, the reduction in size of the module yields a display device ideal for portable digital equipment, such as digital still cameras.

However, in the LCD shown in FIG. 1, the decoder 150 and the selector 170 providing D/A conversion are necessary for every column (every drain line), resulting in a large number of circuit elements which must be formed on the LCD substrate, thereby increasing the size of the circuit in proportion to the increase in the number of drain lines. It is therefore difficult to adopt the circuit configuration shown in FIG. 1 for high-resolution panels having a narrow pitch between drain lines. Furthermore, as the circuit size increases, the power consumption increases accordingly so as to preclude its use as a display panel in portable equipment requiring low power consumption.

Furthermore, these circuits are formed from the same p-Si TFT elements as the TFTs 90 of the display pixel. However, the number of TFT elements becomes extremely large. If even one TFT element is defective, the entire display apparatus is considered defective.

Thus, a drop in yield and an increase in manufacturing cost were problems.

Furthermore, if the number of bits increases, the size of the circuits of the D/A converters for each row increases so that the above-mentioned problems become more pronounced.

### SUMMARY OF THE INVENTION

It is therefore an object of the present invention to solve the aforementioned problems and to realize a circuit for digital-analog conversion with minimum configuration.

In order to achieve this object, the present invention is a drive circuit for display apparatus, in which display pixels are arranged in matrix form, with the drive circuit comprising: a decoder circuit for generating 2ⁿ (where n is a natural number) control signals from n-bit input digital video data; and 2ⁿ analog switches arranged so as to respectively correspond to the 2ⁿ control signals, and controlled so as to turn on and off by corresponding signals among the 2ⁿ control signals, and respectively connected to 2ⁿ different types of signal sources; wherein signal from corresponding one of said signal sources among 2ⁿ types is output toward corresponding display pixels from one of 2ⁿ analog switches controlled so as to turn on on the basis of the input digital video data.

In the display apparatus relating to another aspect of the present invention, a plurality of disposed display pixels and at least one drive circuit are formed on the same substrate for supplying pixel signals to the display pixels so as to control said display pixels, with the drive circuit comprising: the decoder circuit for generating 2ⁿ (where n is a natural number) control signals from n-bit input digital video data; and 2ⁿ analog switches disposed so as to respectively correspond to the 2ⁿ control signals, and controlled so as to turn on and off by corresponding signals among the 2ⁿ control signals, and respectively connected to 2ⁿ different types of signal sources; wherein signals from corresponding signal sources among 2ⁿ types are output toward corresponding display pixels from one of 2ⁿ analog switches controlled so as to turn on on the basis of the input digital video data.

In this manner, the input digital video data signals are converted from digital to analog to generate video signals, thereby eliminating the need to integrate D/A converter for every column and reducing the overall circuit size. Furthermore, the circuit area can be reduced by increasing the degree of integration of the decoder area.

In another aspect of the present invention, the display pixels have pixel transistors for switching updates of pixel signal; and the decoder circuit and/or the analog switch are/is formed on the same substrate with the pixel transistors and configured with substantially the same transistor structure.

When the pixels and pixel drive circuits are formed on the same substrate, the above-mentioned configuration makes it possible to reduce the circuit size of the drive circuit area, thereby making it easy to miniaturize the display apparatus, in particular to further narrow the periphery of the display apparatus.

In another aspect of the present invention, the drive circuit further comprises a shifter circuit for shifting the voltage levels of 2ⁿ control signals that are output from the decoder circuit.

As a result, the supply voltage of the decoder area can be lowered and the power consumption can be decreased.

As can be clearly seen from the above description, in the display apparatus capable of directly inputting digital video data, the circuit size of the built-in D/A converter and the area occupied are reduced so as to achieve not only miniaturization of the overall display apparatus but also reduction in the power consumption of the D/A converters.

### BRIEF DESCRIPTION OF THE DRAWINGS

FIG. 1 is a block diagram of a display apparatus with built-in digital driver of the prior art.

FIG. 2 is a block diagram of the display apparatus with built-in digital driver relating to a first aspect of the present invention.

FIG. 3A shows a simplified cross-sectional view of a pixel area TFT of the display apparatus of the present invention.

FIG. 3B shows a simplified cross-sectional view of a driver TFT of the display apparatus of the present invention.

FIG. 4 shows drive waveforms at various parts of the display apparatus of the present invention.

FIG. 5 is a block diagram of the display apparatus with built-in digital driver relating to a second aspect of the present invention.

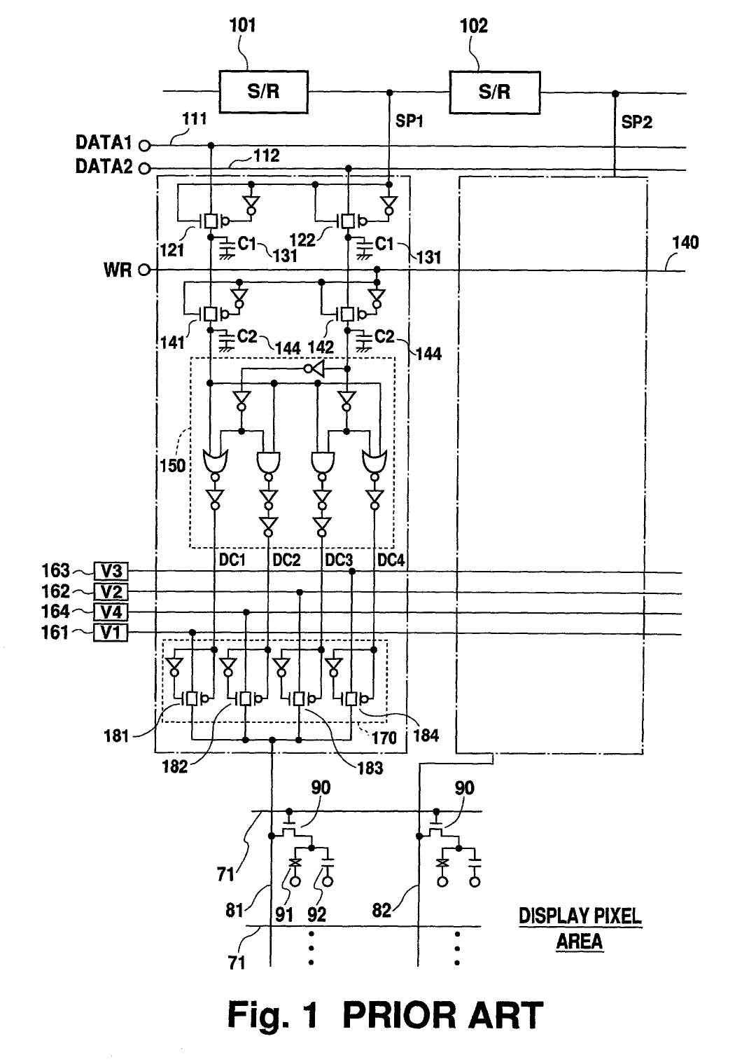

### DESCRIPTION OF THE PREFERRED EMBODIMENT

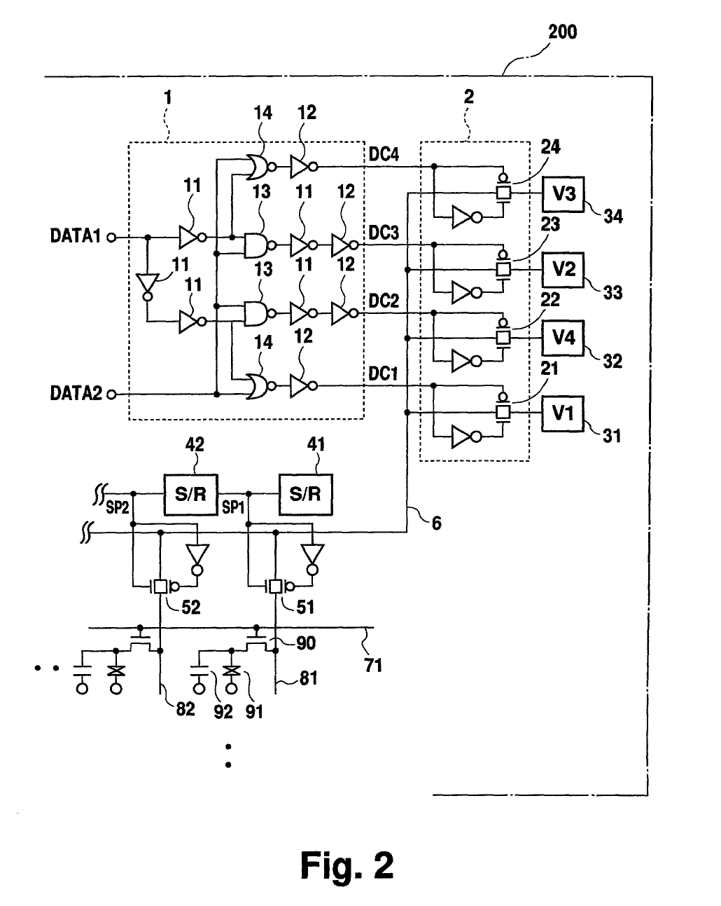

FIG. 2 is a block diagram of the LCD with built-in digital driver relating to a first aspect of the present invention. The top left part of the drawing shows a decoder 1 and the top right part shows a selector 2, which is controlled by the decoder 1. The bottom part of the drawing shows a drain driver comprising horizontal shift registers 41, 42, and so forth, a video line 6, and sampling switches 51, 52, and so forth; gate lines 71 and so forth and drain lines 81, 82, and so forth arranged so as to mutually intersect; and a display pixel area comprising a pixel area TFT 90 formed at each intersection to which are connected a liquid crystal capacitor 91 and an auxiliary capacitor 92.

The decoder 1 and the selector 2 form the built-in D/A converter relating to the present invention.

The decoder 1 comprises inverters 11, 12, NAND gates 13, and NOR gates 14, and decodes 2-bit input digital data to generate and supply to the selector 2 one of four control signals DC1, DC2, DC3, and DC4.

The selector 2 comprises first to fourth analog switches 21, 22, 23, 24, and each switch is switched on-off by the control signals DC1, DC2, DC3, and DC4 supplied from the decoder 1. Furthermore, these analog switches 21, 22, 23, 24 are each supplied with polarity inverted voltages V1, V2, V2, and V4 (V1<V2<V3<V4) having four mutually different levels from first to fourth signal sources 31, 32, 33, 34, which generate polarity inverted voltages having mutually different amplitudes. These signal sources 31, 32, 33, 34 are connected to the video line 6 through the analog switches 21, 22, 23, 24.

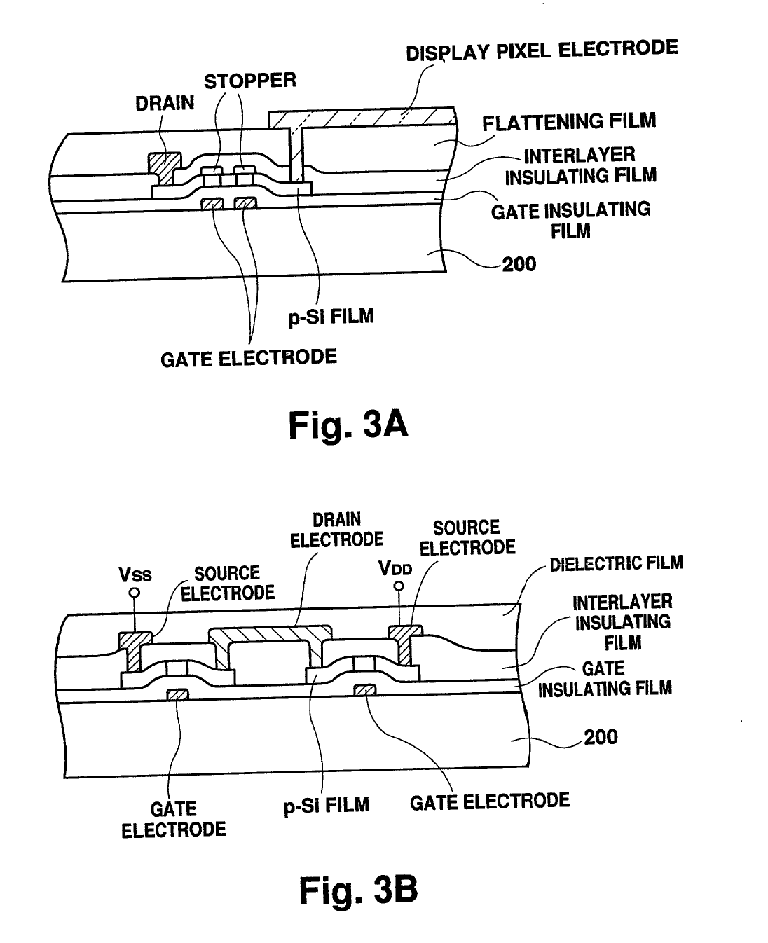

The digital driver area for driving the display pixel area, namely, the decoder 1, the selector 2, and the drain driver (horizontal shift registers 41, 42, and so forth, sampling switches 51, 52, and so forth), are configured from CMOS circuits using p-Si TFT elements (refer to FIG. 3B) having structures identical to the TFT of the display pixel area shown in FIG. 3A.

The pixel area TFT and the p-Si TFT element of the driver area are formed on a same glass substrate 200 by substantially identical processes, and basically comprise gate electrodes, a gate insulating film, a p-Si film (channel region, source region, and drain region), source electrodes connected to the source region through contact holes formed in the interlayer insulating film, and drain electrodes connected to the drain region. Furthermore, the p-Si film is a polycrystalline silicon film formed from the poly-crystallization of an a-Si film through a laser annealing process. In the pixel area TFT, a display pixel electrode, such as one which is configured from ITO (Indium Tin Oxide), is connected to the source region of the p-Si film, and in the TFT of the driver area, a CMOS circuit is configured with a p-channel TFT and an n-channel TFT having different conduction channels provided together with the drain electrodes (or drain region) in common.

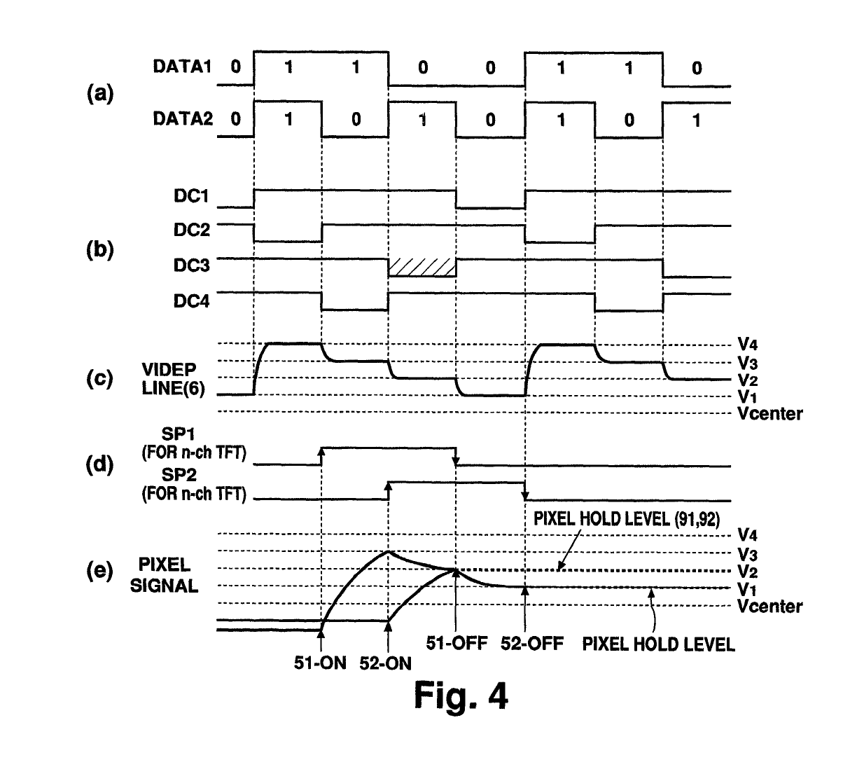

An operation of the LCD with built-in digital driver of FIG. 2 will be described in the following with reference to FIG. 4.

The decoder 1 is input with 2-bit 4 gray scale level digital data of DATA1 and DATA2 (refer to FIG. 4(a)). By decoding the digital data, the decoder 1 generates and outputs one of the first to fourth control signals to the selector 2. For example, as shown by waveforms (b) in the drawing, in accordance with the input digital data DATA1 and DATA2, the level of one corresponding control signal from DC1 to DC4 becomes a level (shown here as L) different from the other control signals. When the input digital data DATA1 and DATA2 are “01”, namely, in an example when they represent the second gray scale, the third control signal DC3 that is output from the decoder 1 becomes level L, and the CMOS analog switch 23, which is supplied with this third control signal DC3, turns on. As a result, the second level voltage V2 supplied from the second signal source 33 to the analog switch 23 is applied to the video line 6 via the analog switch 23.

In this manner, in accordance with the n-bit (shown here as n=2) digital video data DATA1 and DATA2 received in succession, one voltage signal of 2ⁿ types of levels V1 to V4 is output to video line 6 from one of 2ⁿ signal sources, the first to fourth signal sources 31, 32, 33, 34 in the example, via one of the corresponding 2ⁿ (4) analog switches 21, 22, 23, 24 (refer to FIG. 4(c)). As shown in FIG. 4(c), the signal that is output to video line 6 is an analog video signal, and D/A conversion is performed by the built-in driver circuit formed on the substrate in the LCD of the present invention. The voltages V1 to V4 that are output from signal sources 31 to 34 have their polarities inverted at a predetermined period as described above, and FIG. 4(c) shows the waveform for the case where voltages V1 to V4 have positive polarities.

In the digital drain driver of the present invention of the so-called dot-sequential drive system, the sampling switches 51, 52, and so forth, are controlled so as to turn on in succession in accordance with the sampling pulses SP1 and SP2, and so forth, that are output in succession (refer to FIG. 4(d)) from the horizontal shift registers 41, 42, and so forth. For this reason, the analog video signal that was output to the video line 6 is sampled by the sampling switches 51, 52, and so forth, that were turned on, and supplied as the pixel signal to the corresponding drain lines 81, 82, and so forth (refer to FIG. 4(e)).

In the display pixel area, the scan signal (for example, a scan signal that is an H level during one horizontal period) that turns on all the pixel area TFTs 90 connected to the same gate line during one horizontal period is applied to the gate line 71 and so forth. For this reason, the pixel signal supplied in succession to the drain lines 81, 82, and so forth, is controlled so as to turn on by the scan signal and is supplied to the liquid crystal capacitor 91 and the auxiliary capacitor 92 via the pixel area TFT connected to the corresponding drain line, and the capacitors 91, 92 store a voltage in accordance with the pixel signal supplied during one pixel display period (refer to FIG. 4(e)).

In the present invention, the analog switches 21, 22, 23, 24 for supplying sufficient current to directly drive the display pixels, and the inverters 12 for supplying the control voltages DC1, DC2, DC3, and DC4 to the analog switches 21, 22, 23, 24 are assumed to be sufficiently large transistors, while the other transistors in the decoder 1 have a minimal size sufficient for logic operations. The decoder 1 and the selector 2 are configured from CMOS circuitry using all p-Si TFTs for low power consumption. Miniaturizing the size of many transistors in the decoder 1 enables the area occupied by the overall circuit to be small and the power consumption to be further reduced.

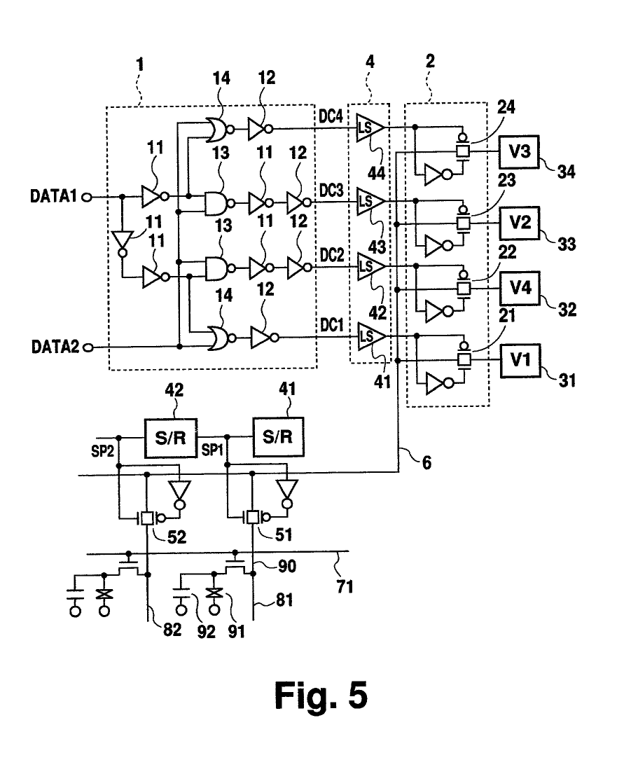

FIG. 5 is a block diagram of the LCD with built-in digital driver relating to a second aspect of the present invention. In this aspect, a level shifter 4 is provided between the decoder 1 and the selector 2. The level shifter 4 comprises first to fourth level shift circuits 41, 42, 43, 44, and each shift circuit raises the voltage levels of the control signals DC1, DC2, DC3, and DC4 that are output from the decoder 1. Due to the level-shifted control signals DC1 to DC4, the analog switches 21 to 24 can be sufficiently driven for outputting currents having sufficient levels to drive the display pixels from the signal sources 31 to 34. Except for the level shifting of the control signals DC1 to DC4, the LCD of this aspect operates in a manner identical to the waveforms shown in FIG. 4.

Therefore, in an instance where a certain magnitude of amplitude is necessary for the voltage signals that are to be output from the signal sources 31 to 34 in order to drive the display pixels, the supply voltage of the decoder 1 can be lowered as much as possible so that even if the number of bits increases and the circuit size of the decoder 1 increases, an increase in power consumption can be suppressed.

Furthermore, in the above-mentioned aspects, examples were described using the liquid crystal display apparatus as the display apparatus. However, a similar effect can also be obtained for other types of display apparatus. For example, in an organic EL display apparatus using organic electroluminescence elements for the display pixels, a configuration is employed where TFTs are formed, using p-Si film as the active layer, as switch elements for driving the pixels on the same substrate in the same manner as the above-mentioned TFT LCD, and where p-Si TFTs are formed having a structure identical to the display area TFTs as driver circuits in order to drive the TFTs in the display area. In this type of display apparatus, the decoder circuit is provided for decoding n-bit input digital data and outputting 2ⁿ control signals. Furthermore, when a configuration is employed where 2ⁿ types of display signals are output from 2ⁿ analog switches in accordance with the control signals, a display apparatus can be obtained featuring a digital-analog conversion function with an extremely simple structure and a minimum number of elements.

While there has been described what are at present considered to be preferred embodiments of the invention, it will be understood that various modifications may be made thereto, and it is intended that the appended claims cover all such modifications as fall within the true spirit and scope of the invention.

What is claimed is:

1. A drive circuit for display apparatus, in which display pixels are disposed in matrix form, the drive circuit comprising:
a decoder circuit for generating 2ⁿ (where n is a natural number) control signals from n-bit input digital video data; and
2ⁿ analog switches disposed so as to respectively correspond to said 2ⁿ control signals, and controlled so as to turn on and off by corresponding signals among said 2ⁿ control signals, and respectively connected to 2ⁿ different types of signal sources;
wherein signal from corresponding one of said signal sources among 2ⁿ types is output toward corresponding said display pixels from one of 2ⁿ analog switches controlled so as to turn on on the basis of said input digital video data.

2. The drive circuit for display apparatus according to claim 1 wherein:
said display pixels have pixel transistors for switching updates of pixel signal; and
said decoder circuit and/or said analog switch are/is formed on the same substrate with said pixel transistors and configured with substantially the same transistor structure.

3. The drive circuit for display apparatus according to claim 1 further comprising a shifter circuit for shifting the voltage levels of 2ⁿ control signals that are output from said decoder circuit.

4. The display apparatus, in which a plurality of disposed display pixels and at least one drive circuit are formed on the same substrate for supplying pixel signals to said display pixels so as to control said display pixels, said drive circuit comprising:
the decoder circuit for generating 2ⁿ (where n is a natural number) control signals from n-bit input digital video data; and
2ⁿ analog switches disposed so as to respectively correspond to said 2ⁿ control signals, and controlled so as to turn on and off by corresponding signals among said 2ⁿ control signals, and respectively connected to 2ⁿ different types of signal sources;
wherein signals from corresponding signal sources among 2ⁿ types are output toward corresponding said display pixels from one of 2ⁿ analog switches controlled so as to turn on on the basis of said input digital video data.

5. The display apparatus according to claim 4 wherein:
said display pixels comprise pixel transistors for switching updates of pixel signal; and
said decoder circuit and/or said analog switch are/is formed on the same substrate with said pixel transistor and configured with substantially the same transistor structure.

6. The display apparatus according to claim 4 further comprising the shifter circuit for shifting the voltage levels of 2ⁿ control signals that are output from said decoder circuit.
